(19) United States
(12) Patent Application Publication
(10) Pub. No.: US 2010/0313054 A1
(43) Pub. Date: Dec. 9, 2010

(54) APPARATUS AND METHOD FOR CURRENT SAVING IN PORTABLE TERMINAL

(75) Inventors: Sang-Won LEE, Seongnam-si (KR); Dong-Hoon KIM, Hwaseong-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/794,073

(22) Filed: Jun. 4, 2010

(30) Foreign Application Priority Data
Jun. 5, 2009 (KR) 10-2009-0049747

(51) Int. Cl. G06F 1/26

(52) U.S. Cl. 713/340

(57) ABSTRACT

A method and apparatus for saving current consumption in a standby state of a portable terminal are provided. The method includes performing a Received (Rx) power determination, and performing at least one function corresponding to a period of the Rx power determination.

### PRIORITY

This application claims the benefit under 35 U.S.C. §119(a) of a Korean patent application filed in the Korean Intellectual Property Office on Jun. 5, 2009 and assigned Serial No. 10-2009-0049747, the entire disclosure of which is hereby incorporated by reference.

### BACKGROUND OF THE INVENTION

1. Field of the Invention

The present invention relates to a portable terminal. More particularly, the present invention relates to an apparatus and method for saving current consumption in a standby state of a portable terminal.

2. Description of the Related Art

In portable terminals, methods for saving current consumption have been suggested to overcome the limited power supply of a battery.

Methods for saving current consumption are divided into two methods. One method depends upon hardware (i.e., its performance is critically determined by properties of each component or circuit design), and the other method depends upon software (i.e., current consumption is saved through an algorithm provided by the software without change of the hardware). In a portable terminal, whether the chosen method depends on hardware or software is determined as follows.

A base current indicates a minimum current required for maintaining a state in the portable terminal after the power is turned on. Herein, the base current is generally dependent on hardware. Frequency indicates how often operations requiring current consumption beyond the base current occur. The frequency is mainly dependent on software. Continuance, related to a current consumed while a preset operation is performed, indicates the time during which the requisite current is continuously provided for the preset operation. The continuance is also dependent on software. Further, a level indicates a level or amount of current required for a preset operation. The level related to a magnitude is dependent on hardware.

In a standby state, operations for periodically determining various states of the portable terminal are performed according to independent periods each having no interdependency on each other.

Thus, whenever each periodic operation is performed, the portable terminal corresponding to independent periods is frequently changed from a standby state to an active state. The change causes an increase of frequency. As a result, the time in which the portable terminal is maintained in the standby state is reduced as each periodic operation is increased. This increases the current consumption in the standby state.

In the standby state, some functions which are mandatorily executed depend on different periods that have no interdependency on each other, which is set by a timer implemented by hardware or software.

Thus, as the number of functions mandatorily executed in the standby state is increased, current consumption in the standby state increases. Further, since some processes related to the timer use resources in the portable terminal, memory usage is increased.

To save current consumption in the standby state, various methods using a paging period between the portable terminal and a network are suggested.

These methods can decrease current consumption by performing functions in synchronization with the paging period. Herein, the paging period has a different value corresponding to an International Mobile Subscriber Identity (IMSI) of a Subscriber Identity Module (SIM) card and varies according to information delivered from the network.

That is, since each paging period used as a standard for each portable terminal is different from another, it is difficult to standardize the paging periods. Also, the paging periods cannot be used for performing some operations which are mandatorily performed with a fixed period.

Therefore, a need exists for an apparatus and method for decreasing current consumption in a standby state of a portable terminal and saving memory usage in the portable terminal

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for decreasing current consumption of portable terminal in a standby state.

Another aspect of the present invention is to provide an apparatus and a method for saving current consumption of a portable terminal in a standby state by using software without a change of hardware.

Still another aspect of the present invention is to provide an apparatus and a method for saving current consumption of a portable terminal in a standby state by determining a battery voltage at every fixed period determined corresponding to a frequency band, while functions of Received (Rx) Power Determination (RPM) are performed, to reduce the number of cases in which the portable terminal is activated in the standby state.

Yet another aspect of the present invention is to provide an apparatus and a method for minimizing current consumption of a portable terminal, when plural functions are simultaneously performed, by determining a battery voltage while functions of an RPM are performed and the plural functions are scheduled based on parameters including a priority of each function, a weight, and a delay time.

Yet another aspect of the present invention is to provide an apparatus and a method for saving memory usage by simultaneously performing plural functions requested to be mandatorily performed in the portable terminal.

In accordance with an aspect of the present invention, a method for saving current consumption in a standby state of a portable terminal is provided. The method includes performing an RPM, and performing at least one function corresponding to a period of the RPM.

In accordance with another aspect of the present invention, an apparatus for saving current consumption in a standby state of a portable terminal is provided. The apparatus includes a modem for determining an Rx power, and a control unit for performing a determination of the Rx power and performing at least one function corresponding to a period of the determination.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a portable terminal according to an exemplary embodiment of the present invention;

FIG. 2 illustrates a period and a section of a Received (Rx) Power Determination (RPM) in a mobile communication system according to an exemplary embodiment of the present invention;

FIG. 3A illustrates RPM and a battery voltage determination according to an exemplary embodiment of the present invention;

FIG. 3B illustrates a battery voltage determination synchronized with an RPM according to an exemplary embodiment of the present invention;

FIG. 4 is a flowchart illustrating a method for battery voltage determination synchronized with an RPM according to an exemplary embodiment of the present invention;

FIG. 5A illustrates an RPM and plural periodic functions in a standby state of a portable terminal according to an exemplary embodiment of the present invention;

FIG. 5B illustrates an RPM and plural periodic functions in a standby state of a portable terminal according to an exemplary embodiment of the present invention;

FIG. 6 is a flowchart illustrating a method for plural periodic functions synchronized with an RPM in a standby state of a portable terminal according to an exemplary embodiment of the present invention; and

FIG. 7 illustrates a method for running plural periodic functions synchronized with an RPM in a standby state of a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, determination error, determination accuracy limitations and other factors known to skill in the art, may occur in amounts that do not preclude the effect the characteristic was intended to provide.

Exemplary embodiments of the present invention provide an apparatus and a method for saving current consumption in a standby state of a portable terminal.

In an exemplary embodiment of the present invention, a standby state is a state where there is no input from a user, i.e., an idle state of the portable terminal. An active state indicates that the portable terminal performs a function, i.e., consumes at least minimum power required for maintaining the portable terminal in its condition. A Received (Rx) Power Determination (RPM) determines an Rx power of neighboring cells and feeds back a Received Signal Strength Indication (RSSI) to a network periodically. Battery/temperature Analog-to-Digital Converter (ADC) samples are digital values converted from analog values obtained by determining battery voltage and temperature inside the portable terminal in a standby state.

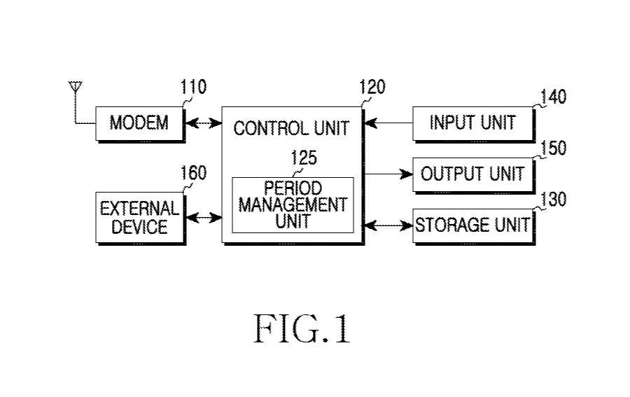

FIG. 1 is a block diagram illustrating a portable terminal according to an exemplary embodiment of the present invention.

Referring to FIG. 1, the portable terminal includes a modem 110, a control unit 120, a storage unit 130, an input unit 140, an output unit 150, and an external device 160.

The modem 110 communicates with and may include another apparatus, such as a wireless processing unit, a base-band processing unit, and the like. The wireless processing unit transforms a signal received by an antenna to a base-band signal and provides the base-band signal to the base-band processing unit. Also, the wireless processing unit coverts a base-band signal delivered from the base-band processing unit into a wireless signal which may be transmitted via a wireless channel by the antenna.

The control unit 120 controls overall operations of the portable terminal For example, the control unit 120 controls processes for voice communication and packet communication. More particularly, according to an exemplary embodiment of the present invention, the control unit 120 controls a period management unit 125. Hereinafter, general functions of the control unit 120 are omitted for convenience of description.

The input unit 140 may include plural input devices such as a keypad, a touch panel, and the like. The input unit 140 delivers data input from a user into the control unit 120.

The output unit 150 displays state information, limited number of characters, plural videos, still pictures, and the like. The output unit 150 may be implemented as a color Liquid Crystal Display (LCD).

The storage unit 130 stores a program configured to control overall operations of the portable terminal and temporary data generated when the program is performed.

The external device 160 includes an additional external device, coupled to the portable terminal, such as a head phone set, a Global Positioning System (GPS) device, and the like.

The period management unit 125 controls the portable terminal to perform a periodic operation in synchronization with a period of the RPM. Also, if there are plural periodic operations, the period management unit 125 sets parameters, such as a priority, a weight, and a delay time, of each function and schedules the plural periodic operations. According to scheduling order, the period management unit 125 performs requested periodic operations corresponding to the period of the RPM. The RPM controlled by the period management unit 125 is performed through the modem 110.

In the above described construction, the control unit 120 may perform functions or operations of the period management unit 125. In an exemplary implementation, the period management unit 125 in the control unit 120 is described additionally in order to distinctly illustrate each function.

Accordingly, in a product manufactured according to an exemplary embodiment of the present invention, all of the functions included in the period management unit 125 may be controlled and performed by the control unit 120, or some of the functions may be processed by the control unit 120.

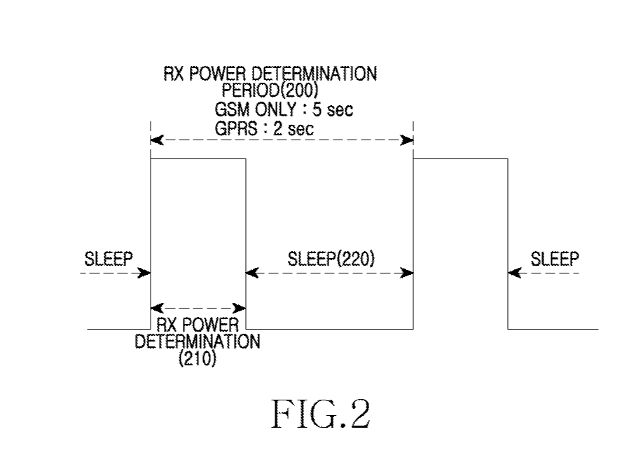

FIG. 2 illustrates a period and a section of an RPM in a mobile communication system according to an exemplary embodiment of the present invention.

Referring to FIG. 2, from a time of starting an RPM period 200 after the portable terminal holds a standby state when there is no input from a user, an Rx power is determined within the period 210. Thereafter, the portable terminal reenters a standby state (i.e., a sleep state) 220. For example, the RPM period 200 is 5 seconds in a case of Global System for Mobile communication (GSM), and 2 seconds in a case of General Packet Radio Service (GPRS).

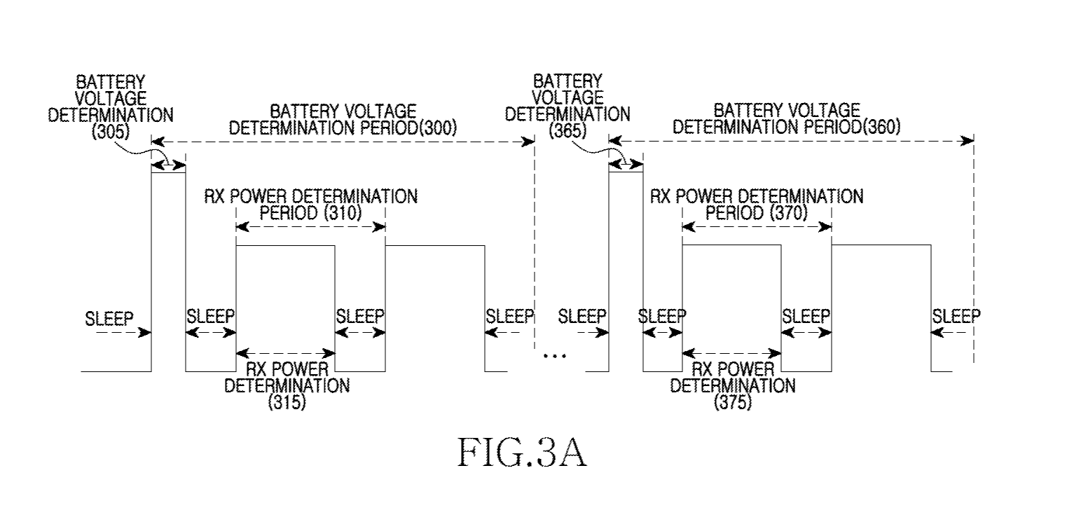

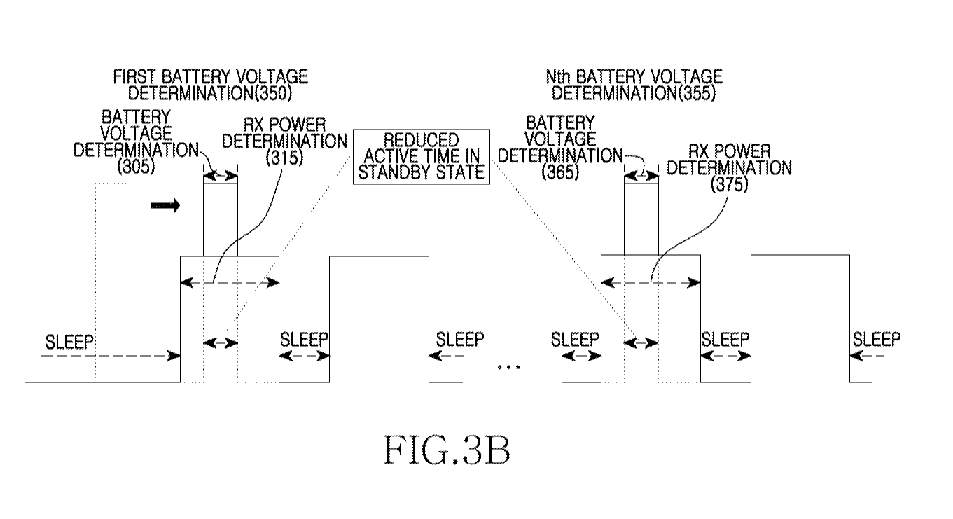

FIG. 3A illustrates an RPM and a battery voltage determination according to an exemplary embodiment of the present invention, and FIG. 3B illustrates a battery voltage determination synchronized with an RPM according to an exemplary embodiment of the present invention.

Referring to FIG. 3A, during a battery voltage determination period 300, 360 in a standby state, the control unit periodically enters an active state (305, 365) and determines a battery voltage of a portable terminal

Also, during an RPM period 310, 370 in a standby state, the control unit periodically enters an active state (315, 375) and determines Rx power of the portable terminal.

Referring to FIG. 3B, in a standby state of the portable terminal, while a first or n^{th} RPM 315, 375 is performed in an RPM period corresponding to the battery voltage determination period 350, 355, the control unit acquires one ADC sample value for the battery voltage determination (305, 365) in each period.

If the ADC sample value is determined up to a preset number which is required for determining an accurate level of battery voltage in each battery voltage determination period synchronized with the RPM period, the control unit acquires an average of the ADC sample values as a final battery voltage value. In an exemplary implementation, the preset number is over 16, which corresponds to a value of multiplying the battery voltage determination period with the number of samples.

That is, the control unit repeatedly performs the operations of gathering a sample value at a time until the number of sample values is counted up to a preset number required for determining an accurate level of battery voltage, and determining an average of the sample values. As a result, the portable terminal may save the total time of an active state in a standby state.

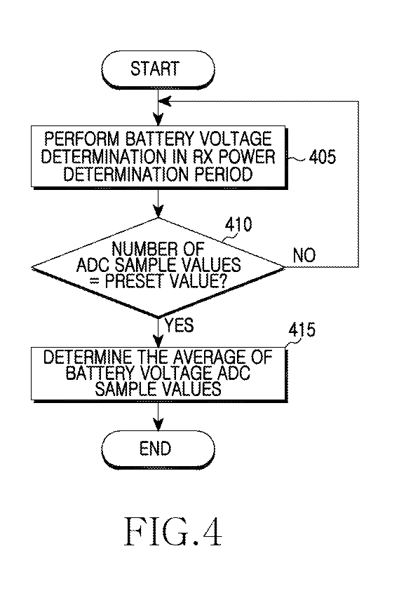

FIG. 4 is a flowchart illustrating a method for battery voltage determination synchronized with an RPM according to an exemplary embodiment of the present invention.

Referring to FIG. 4, an RPM period is 5 seconds in a case of GSM, and 2 seconds in a case of GPRS. Also, a battery voltage determination period is 60 seconds, with an error tolerance of ±2 seconds.

In step 405, when the RPM is performed every 5 seconds in the GSM, the control unit performs the battery voltage determination according to the RPM period after the portable terminal enters a standby state and obtains ADC sample values of the battery voltage determination.

In step 410, the control unit repeatedly performs a battery voltage determination process synchronized with the RPM period until the number of ADC sample values obtained from the battery voltage determination process is the same as a preset value. In an exemplary implementation, the preset value is 16. Since the battery voltage determination period is 60 seconds and the final battery voltage value is an average of the ADC sample values during 960 seconds, the preset value is 16 (960/60).

In order to obtain a battery voltage value after the portable terminal enters a standby state, the control unit acquires a first battery voltage ADC sample value for a 12^{th} RPM period, a second battery voltage ADC sample value for a 24^{th} RPM period, a third battery voltage ADC sample value for a 36^{th} RPM period, a fourth battery voltage ADC sample value for a 48^{th} RPM period, and the like.

That is, the control unit acquires an n^{th} battery voltage ADC sample value for the RPM period of each multiple of 12 (12×n). In a standby state, a time n(t) required for obtaining the n^{th} battery voltage ADC sample value is expressed as Equation (1):

$$n ( t ) = 12 {\sum }_{n = 1}^{16} n \pm 1.2 \qquad ( 1 )$$

The control unit acquires a 16^{th} battery voltage ADC sample value for 192^{nd} RPM period. In step 415, the control unit determines the average of the first to the 16^{th} battery voltage ADC sample values, i.e., all battery voltage ADC sample values during 960 seconds, to obtain the final battery voltage value.

That is, the control unit acquires 16 battery voltage ADC sample values determined during 960 seconds corresponding to the RPM period and determines the average of the 16 battery voltage ADC sample values to output the final battery voltage value.

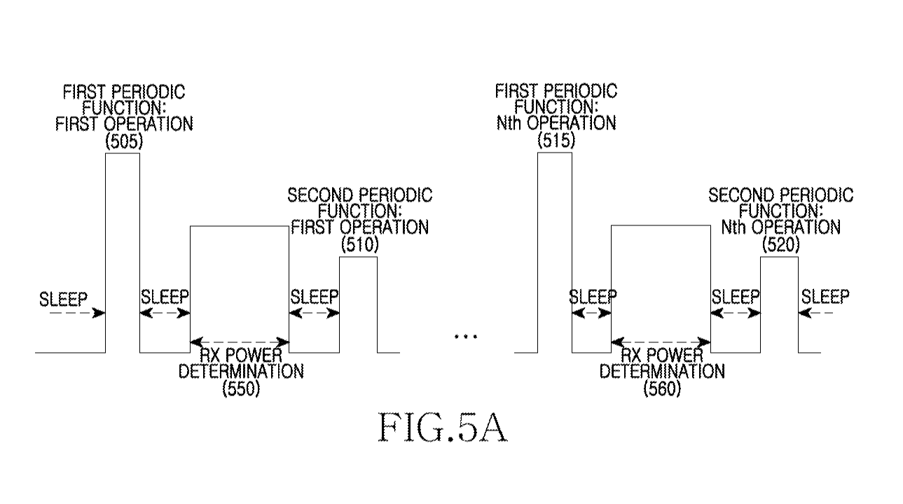

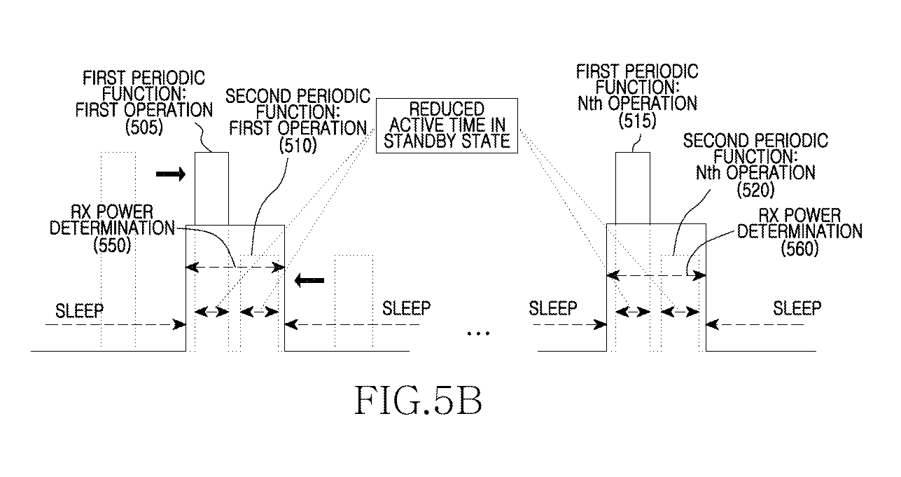

FIG. 5A illustrates an RPM and plural periodic functions in a standby state of a portable terminal according to an exemplary embodiment of the present invention, and FIG. 5B illustrates an RPM and plural periodic functions in a standby state of a portable terminal according to an exemplary embodiment of the present invention.

Referring to FIG. 5A, other periodic functions 505, 510, 515 and 520 generally operate regardless of RPMs 550 and 560.

Referring to FIG. 5B, while an active state is maintained corresponding to a period of the RPM 550 from a timing of a first RPM 550 after the portable terminal enters a standby state when there is no input from a user, the control unit performs together the first and second periodic functions 505 and 510 of the first operation.

Similarly, in a period of performing n^{th} RPM 560, while an active state is maintained corresponding to a period of the RPM 560, the control unit performs first and second periodic functions 515 and 520 of the n^{th} operation. Accordingly, the portable terminal may save the time of the active state in a standby state.

Herein, the various functions may include a battery voltage determination, a temperature determination inside the portable terminal, or a connection validity of a Subscriber Identity Module (SIM) card. The functions may further include determination of an operation state or connection validity of an external apparatus. That is, the functions may include all other functions required in a standby state.

For each of the various functions, parameters such as a priority, a weight, and a delay time may be set to apply a determination.

Herein, the priority is expressed when plural functions have one or more overlapped periods in an RPM period. Factors determining the priority include importance of function and frequency of determination. If the number of sample values required in the same time is more than others, the function related to the sample values has a higher priority than other functions.

The weight may be defined by the number of ADC sample values, which is at minimum required to complete each function consecutively performed within a period that does not exceed the delay time. An initial value of an operating weight is ‘0’, and the operating weight increases by 1 whenever an ADC sample value is obtained. After completing a function, the operating weight of the function is initialized to ‘0’.

That is, the operating weight is increased by 1 whenever a function corresponding to the operating weight is performed at a time until the operating weight is the same as a preset weight. Then, if the operating weight is the same as the preset weight, the operating weight is initialized to ‘0’.

The delay time determines error tolerance against a case when plural periodic functions are not performed within their period. If a function cannot be executed in an RPM period because its priority is low, the function will be performed within the number of periods of the RPM, which corresponds to the delay time.

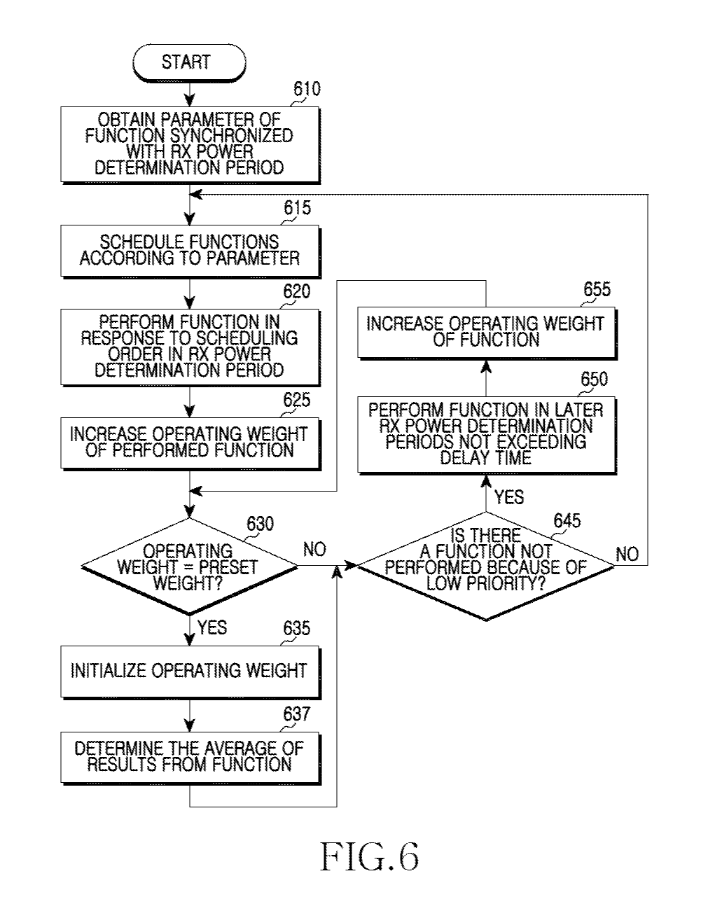

FIG. 6 is a flowchart illustrating a method for plural periodic functions synchronized with an RPM in a standby state of a portable terminal according to an exemplary embodiment of the present invention.

Referring to FIG. 6, in step 610, the control unit obtains parameters of a function performed in synchronization with an RPM period.

As described above, the parameters may include a priority, a weight, a delay time, and the like. Also, initial values of the parameters may be determined based on experimental results by providers, manufacturers, or technical policies.

In step 615, the control unit schedules plural functions according to the parameters. For example, the control unit may determine an operational sequence of the plural functions based on priorities among their parameters.

In step 620, the control unit performs functions corresponding to the operational sequence or scheduling order in the RPM period. If any function is performed, an ADC sample value related to the function may be obtained. In step 625, an operating weight of the corresponding function is increased by 1. Herein, the operating weight indicates a present weight of each function. The operating weight is changed by the number of obtained sample values.

The control unit performs each function repeatedly until an operating weight of a corresponding function is the same as the weight thereof.

In step 630, it is determined whether the operating weight of the function is the same as a preset weight. If it is determined that the operating weight is the same as the preset weight, i.e., the function is completed, in step 635, the operating weight of the function is initialized to ‘0 ’. In step 637, the average of sample values is determined to acquire a final determination value.

In step 645, it is determined whether some functions having a low priority are not performed. In step 650, the functions are performed in a later RPM period within a period which does not exceed the delay time. In step 655, operating weights of the performed functions are increased. In step 630, it is determined again whether the operating weight of each function is the same as the preset weight.

In step 630, if it is determined that the operating weight is not the same as the preset weight, in step 645, it is determined whether another function having a low priority is not performed. In step 650, if it is determined that another function having a low priority is not performed, the function is performed in a later RPM period within a period which does not exceed the delay time. In step 655, the operating weight of the function is increased. In step 630, it is determined again whether the operating weight of the function is the same as the preset weight.

In step 645, if it is determined that there is a function not performed because of its low priority, the process returns to step 615, and the control unit schedules plural functions again according to the parameters. Based on the operational sequence or scheduling order, the functions are performed.

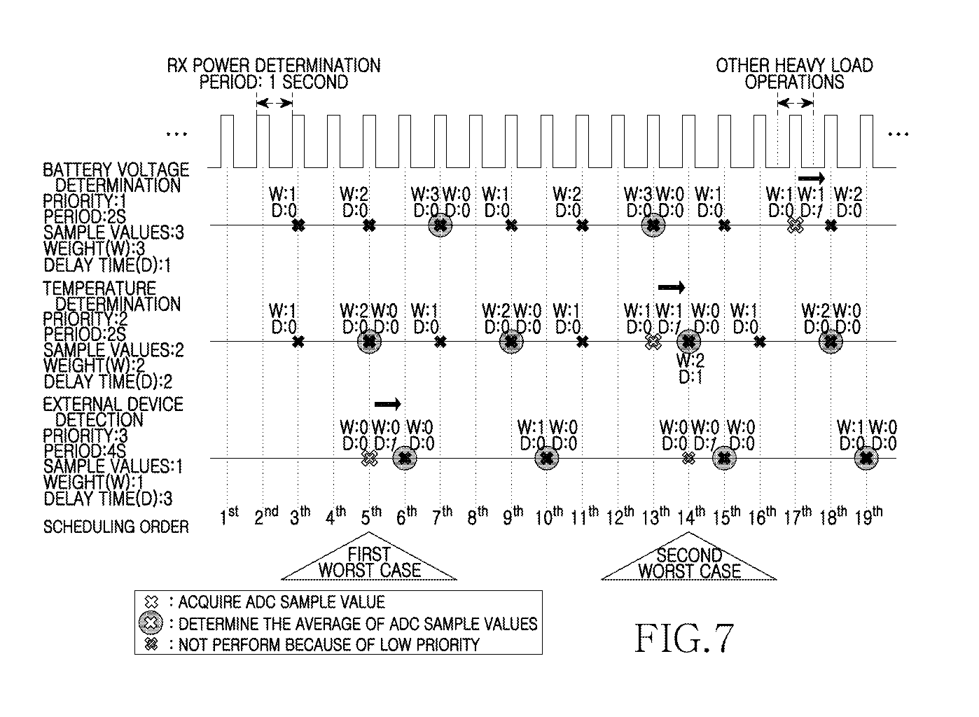

FIG. 7 illustrates a method for running plural periodic functions synchronized with an RPM in a standby state of a portable terminal according to an exemplary embodiment of the present invention.

Referring to FIG. 7, an RPM period is set to 1 second, and a weight W and a delay time D are also set to 1 second. For example, detailed processes of a temperature determination, as one of other periodic functions performed within the RPM period in a standby state, are described as follows.

In the temperature determination, the control unit obtains an ADC sample value every 60 seconds and four ADC sample values during 240 seconds. The control unit determines the average of the four ADC sample values to output a final temperature value. Herein, the RPM is performed every 2 seconds.

In the temperature determination, one ADC sample value of the temperature determination may be obtained every 30-times RPMs. An example of a temperature determination method synchronized with the RPM is expressed as Equation (2):

60(sec)=2(sec)*Cnt_{RPM}±5(sec) Cntᵣₚₘ≈30(times) (2)

where 5 (sec) is an error tolerance, and Cntᵣₚₘ is the number of times performing the RPM.

If there is at least one function not performed because its priority is low, the function is performed as follows.

First, the number of RPM periods as time passes is updated. The numbers of times, performing the RPM, requested for completing each function are managed as a list (or an arrangement). In a predetermined RPM period, a corresponding function is performed.

Further, within a period that does not exceed the delay time defined according to a function, at least one function not performed in the present RPM period is performed in a next RPM period. That is, worst cases are evaded through scheduling plural functions.

This method uses maximum time activated which corresponds to the RPM period in a standby state so that current consumption may be saved. Using the parameters, the control unit repeatedly performs the above described operation while in a standby state when a user's input is not maintained.

A first worst case shows that, although a battery voltage determination, a temperature determination, and external apparatus detection should be simultaneously performed in a RPM period, the external apparatus detection is not performed in a 6^{th} time and a 5^{th} time, because its priority is low.

A second worst case shows that, although a battery voltage determination, a temperature determination, and external apparatus detection should be simultaneously performed in a RPM period, the temperature determination is not performed in a 14^{th} time and a 13^{th} time, because it's priority is low. The external apparatus detection is performed in a 15^{th} time and not a 14^{th} time, because its priority is also low.

Further, another function having a big load is performed. If the function having a big load has a higher priority than a battery voltage determination, the battery voltage determination is not performed in a 17^{th} time being a preset period, but performed in an 18^{th} time which is the next period of original assignment.

An exemplary embodiment of the present invention includes a fixed period in a standby state and schedules plural functions to perform at least one periodic function at maximum times for a mandatorily activated time. Accordingly, a frequency of converting into an active state in a standby state may be saved. Thereby, current consumption in a standby state is decreased. For example, based on a test result of implementation related to the battery voltage determination, current consumption can be decreased by an average rate of about 0.05 to 0.1 mA every 10 minutes.

Further, an exemplary embodiment of the present invention has an advantage of saving memory usage by simultaneously performing plural requested functions.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for saving current consumption in a standby state of a portable terminal, the method comprising:
Performing, by a control unit, a Received (Rx) Power Determination (RPM); and
performing, by the control unit, at least one function corresponding to a period of the RPM.

2. The method of claim 1, further comprising scheduling at least one function based on a parameter of the at least one function.

3. The method of claim 2, wherein the parameter comprise at least one of a priority, a weight, a delay time, a number of sample values, and a period.

4. The method of claim 1, wherein the performing of the at least one function comprises:
accumulating an Analog-to-Digital Convert (ADC) sample value from the at least one function until the number of accumulated ADC sample values is equals a weight; and
determining the average of accumulated ADC sample values.

5. The method of claim 4, wherein the weight comprises an operating weight which is a minimum required to complete the at least one function consecutively performed within a period which does not exceed a delay time.

6. The method of claim 5, wherein the operating weight comprises an initial value of ‘0 ’ and the operating weight increases by ‘1 ’ when the ADC sample value is obtained.

7. The method of claim 6, wherein the operating weight is increased by ‘1 ’ when a function corresponding to the operating weight is performed at a time until it is determined whether the operating weight is the same as a preset weight.

8. The method of claim 7, wherein, if it is determined that the operating weight is the same as the preset weight, the at least one function is completed and the operating weight is initialized to ‘0’.

9. The method of claim 8, wherein, if it is determined that the operating weight is not the same as the preset weight, it is determined whether another function having a low priority is not performed.

10. The method of claim 9, further comprising performing the other function in later periods of the RPM without exceeding the delay time of the function, if the other function is not performed due to the low priority.

11. An apparatus for saving current consumption in a standby state of a portable terminal, the apparatus comprising:
a modem for determining an Rx power; and
a control unit for performing a determination of the Rx power and performing at least one function corresponding to a period of the determination.

12. The apparatus of claim 11, wherein the control unit schedules at least one function based on at least one parameter of the at least one function.

13. The apparatus of claim 12, wherein the parameter comprise at least one of a priority, a weight, a delay time, the number of sample values, and a period.

14. The apparatus of claim 11, wherein the control unit accumulates an Analog-to-Digital Convert (ADC) sample value from at least one function until the number of accumulated ADC sample values is equals to a weight, and determines the average of accumulated ADC sample values.

15. The apparatus of claim 14, wherein the weight comprises an operating weight which is a minimum required to complete the at least one function consecutively performed within a period which does not exceed a delay time.

16. The apparatus of claim 15, wherein the operating weight comprises an initial value of ‘0 ’ and the operating weight increases by ‘1’ when the ADC sample value is obtained.

17. The apparatus of claim 16, wherein the operating weight is increased by ‘1’ when a function corresponding to the operating weight is performed at a time until it is determined whether the operating weight is the same as a preset weight.

18. The apparatus of claim 17, wherein, if it is determined that the operating weight is the same as the preset weight, the at least one function is completed and the operating weight is initialized to ‘0’.

19. The apparatus of claim 18, wherein, if it is determined that the operating weight is not the same as the preset weight, it is determined whether another function having a low priority is not performed.

20. The apparatus of claim 19, wherein, if the other function is not performed due to the low priority, the control unit performs the other function in later periods of the RPM without exceeding the delay time of the function.
